(19) United States
(12) Patent Application Publication
(10) Pub. No.: US 2009/0159508 A1
(43) Pub. Date: Jun. 25, 2009

(54) Relational scheme assignment

(75) Inventors: Paul Kostyniuk, Wilmette, IL (US); Brian Bowers, Mundelein, IL (US); Gary Van Ermen, Palatine, IL (US)

Correspondence Address: MCDERMOTT WILL & EMERY LLP, 600 13TH STREET, N.W., WASHINGTON, DC, 20005-3096, US

(73) Assignee: Bowe Bell + Howell Company

(21) Appl. No.: 12/003,226

(22) Filed: Dec. 20, 2007

(51) Int. Cl. B07C 3/12; B07C 5/38; G06F 7/08

(52) U.S. Cl. 209/584; 700/226

(57) ABSTRACT

A method and system are provided for mail item processing within a mail sort environment. In particular, a method and system are provided for allowing different mail sort schemes that share common sort parameters to be referenced to one another in a mail sort environment. There is further provided a method and system to permit mail sort parameter changes as applied to one sort scheme to be readily reflected in any other sort schemes that share the same sort parameters.

### TECHNICAL FIELD

The subject matter discussed herein relates to a method and system for mail item processing, and particularly, a method and system for processing mail items within a sorter environment.

### BACKGROUND

Document processing facilities often use high speed document processing machines such as sorters, to sort and direct mail items appropriately to one or more mail bins for distribution. The efficiency of a sorter is generally dependent upon various factors, including the rate at which mail items can be fed into a mail transport and subsequently transported along a transport path via a system of mechanized pulleys, levers and rollers, the ability for the address components (e.g., recipient address, ZIP code, bar code) marked upon the mail items to be identified by a reader device for association of each mail piece with a sort scheme managed by a sort scheme computer, and the number of mail items that can be effectively accumulated by a mail stacker into one or more mail pockets or bins as directed by the sort scheme. Hence, while sorter efficiency can be measured to some extent on the basis of physical phenomenon such as described above, sorter effectiveness is more a matter of the quality of the sort schemes employed.

Sort schemes are programmable instructions that affect and influence the behavior of the sorter device. More specifically, a sort scheme defines how mail items having varying characteristics—be they physical characteristics such as height and weight or unique identifier based characteristics such as barcodes or ZIP Codes—are to be sorted into various mail bins maintained by the sorter. This may include instructions for: enabling or disabling inline processing devices (e.g., scales, printers or labelers) intended for operation upon the mail items, activating or deactivating of one or more solenoids, pickers, pulleys or lever arms useful for guiding mail items in varying directions along a transport path of the sorter, etc. Generally, a sort scheme is generated for handling mail items having certain limited sets or combinations of characteristics, whereby said characteristics become sort parameters that when identified during sorter processing, trigger the execution of the sort scheme. So, for example, a first sort scheme may be crafted for handling mail items that are determined to weigh 3 ounces and correspond to ZIP Codes ranging from 90210-90229, while a second sort scheme may apply to the same range of ZIP Codes for mail items of less than 3 ounces. Suffice to say, in this example the specified weight and zip ranges are sort parameters, while the accumulation of mail items on the basis of common sort parameters forms mail groupings. Each sort scheme is therefore a function of the one or more sort parameters (i.e., one or more mail item characteristics), detectable during sort processing such as by an imaging device or scale mechanism, ultimately for the aggregation of mail items into groupings. Sort processing of disparate mail items into mail groupings associated by common postal authority recognized sort parameters leads to increased postal processing and postal authority work sharing discounts.

In some instances, several sorters are necessary to process large volume mailings. Generally, such an arrangement entails the usage of a first sorter for conducting a first pass or initial processing of mail items to determine the characteristics of the overall mailing, performed using an initial sort scheme. The initial sort scheme may itself comprise a plurality of sub-schemes, where each sub-scheme is geared towards facilitating the sort of the mail items into select mail groupings. First pass processing is typically followed by usage of the first sorter and/or one or more additional sorters for performing second pass or subsequent processing of the select mail groupings using one or more other sort schemes. When feasible, the one or more additional sorters perform static second pass processing of the mail grouping, wherein the characteristics of the mail is known in advance of processing by the one or more additional sorters; particularly, because the characteristics (e.g., ZIP Codes) of the mail groupings were ascertained during first pass, but require additional processing for a finer level of sort. A particular advantage of static second pass processing is: (1) the large volume mailing need not be limited to processing by only the first sorter, (2) having determined the mail characteristics during first pass, the one or more additional sorters may operate upon select groupings of mail as a way of work distribution, and (3) sort efficiency may be increased because the multiple sorters may operate upon the entire mailing concurrently as opposed to sequentially or singularly. Suffice to say, multiple different sort schemes are required to process a large volume of mail items having varying characteristics, and hence sort parameters, upon which to sort.

As several differing sort schemes are required, it is not uncommon for differing sort schemes to share common sort parameters. This is especially true of the relationship between a first pass sort scheme and a static second pass sort scheme, wherein there is a parent to child relationship respectively between said schemes. So, for instance, the first pass scheme as employed via a first sorter may consist of several sub-schemes that are a function of various sort parameters, while the one or more additional sorters required for running static second pass processing may employ some of those very same sub-schemes. Given the association of these sort schemes, it is desired that a change in a particular sort parameter for a static second pass scheme also be easily reflected in the first pass sort scheme for which it is related. Conversely, the reverse would also be desired. Nevertheless, there exists no process today by which a change in one or more sort parameters for a particular sort scheme—that is related to another sort scheme one the basis of the same one or more sort parameters to be changed—may result in the same change being reflected for both.

To overcome the above described challenges, a method and system is needed for enabling different sort schemes that share common sort parameters to be easily related to one another in a sort environment. In this way, easy association of related schemes may commence whether in a distributed or non-distributed sorter environment. Furthermore, there exists a need for enabling sort parameter changes as applied to one sort scheme to be readily reflected in any other sort schemes that share the same sort parameters. In this way, each related sort scheme as implemented upon a different sorter need not be modified manually, as is common practice today.

### SUMMARY

It is desirable to provide a method for generating a plurality of mail sort schemes used to control operation of one or more mail sorting devices. The method includes creating a first mail sort scheme and a second mail sort scheme wherein each mail sort scheme includes instructions for sorting mail items. The instructions are executed based at least in part on one or more mail item sort parameters common in each mail sort scheme. The method includes generating a relational identification tag to associate the first and second mail sort schemes based on the one or more common mail item sort parameters and storing the first and second mail sort schemes and the relational identification tag for access by the one or more mail sorting devices. The second mail sort scheme is referenced by the relational identification tag when the first mail sort scheme is accessed by the one or more mail sorting devices.

In accord with the present concepts disclosed herein, there is provided a method for updating a plurality of mail sort schemes having one or more mail item sort parameters in common. The method includes assigning a relational identification tag to a first mail sort scheme to reference the first mail sort scheme with a second mail sort scheme. The one or more sort parameters is modified for the first mail sort scheme and the sort parameter is common to the first and second mail sort schemes. The modified first mail sort scheme is stored for access by the one or more sorting devices. The common mail item sort parameter is automatically modified in the second mail sort scheme as modified in the first mail sort scheme, based on the assigned relational identification tag.

It is further desirable to provide a system for generating a plurality of mail sort schemes used to control operation of one or more mail sorting devices. The system includes a sort scheme generator adapted to create first and second mail sort schemes, wherein each mail sort scheme includes instructions for sorting mail items. The instructions are executed by the one or more mail sorting devices based at least in part on one or more mail item sort parameters common in each mail sort scheme. A relational identification tag is generated to associate the first and second mail sort schemes based on the one or more common mail item sort parameters. Included in the system is a database for storing the relational identification tag and the first and second mail sort schemes for access by the one or more mail sorting devices. The relational identification tag references the second mail sort scheme when the first mail sort scheme is accessed by the one or more sorting devices.

In accord with the present concepts disclosed herein, there is further provided a method for generating an effective use date to a modified mail sort scheme. The method includes creating or modifying at least one mail item sort parameter in a mail sort scheme, wherein the modified sort parameter affects the operations of one or more sorting devices. The method includes assigning an effective use date to the created or modified mail sort scheme; and storing the effective use date for access by the one or more sorting devices.

Additional advantages and aspects of the present subject matter will become readily apparent to those skilled in the art from the following detailed description, wherein embodiments of the present subject matter are shown and described, simply by way of illustration of the best mode contemplated for practicing the present subject matter. As will be described, the present subject matter is capable of other and different embodiments, and its several details are susceptible of modification in various obvious respects, all without departing from the spirit of the present subject matter. Accordingly, the drawings and description are to be regarded as illustrative in nature, and not limitative.

### BRIEF DESCRIPTION OF THE DRAWINGS

The following detailed description of the embodiments of the present subject matter can best be understood when read in conjunction with the following drawings, in which the various features are not necessarily drawn to scale but rather are drawn as to best illustrate the pertinent features, and in which like reference numerals are employed throughout to designate similar features.

FIG. 1 depicts a high speed sorter device adapted to process mail items with one or more sort schemes.

FIG. 2 depicts a plurality of high speed sorter devices employing a relational identification tag as a way of relating sort schemes having shared sort parameters to one another.

FIG. 3 depicts an exemplary postal authority scheme assignment table before and after an update is made that affects a sort parameter upon which the mail may be processed.

FIG. 4 depicts a plurality of high speed sorter devices employing differing sort schemes being updated respective to all of the sort schemes.

FIG. 5 is an exemplary flowchart depicting the process by which a change to one or more sort parameters respective to a first sort scheme may be made respective to other sort schemes associated with the same one or more sort parameters.

### DETAILED DESCRIPTION

As used herein, the term “mail piece” or “mail item” refers to any document having human or machine readable content generated thereon, and particularly that intended for delivery to a given recipient. In the context of a general mailing facility, this may include envelopes, newsletters, newspapers, magazines, post cards, parcels or packages of varying thicknesses (e.g., flat mail), coupon booklets, brochures, and any other like documents. Such documents may or may not be generated for the purpose of being distributed via an outgoing distribution channel (e.g., delivery company, postal authority), but rather, may be generated for direct/personal carry, delivery, or internal distribution. When a plurality of such mail items as described above are grouped together (e.g., associated with one another according to a common characteristic or mail item processing rule), this is referred to as a “mail grouping.” Groupings may include a plurality of mail items having a common ZIP code or range thereof, common internal destination point, common physical characteristics, or common rules, limitations, or special instructions as defined in accord with a sort scheme. In the context of a sort scheme, which comprises one or more instructions that dictate how a document processing system is to handle mail items during processing, the common parameters as mentioned above are referred to as “sort parameters.”

Also, as used herein, the phrase document or mail processing system refers to any high speed transport device(s) capable of processing documents at considerably high rates with considerably high precision. Document processing systems may include, but are not limited to, inbound sorting equipment, outbound mail sorting equipment, and even various forms of inserter machines, mail integrity systems, or the like for office, commercial, or industrial settings. A “stacker,” “bin” or “pocket” as used in connection with a document processing system may refer to any device for receiving, accumulating and/or collecting processed mail items. While the foregoing discussion will present the teachings in an exemplary fashion with respect to a conventional sorter device, it will be apparent to those skilled in the art that the teachings may apply to any type of document processing device or system (e.g., inserter, accumulator, etc.) desiring or requiring operational instruction or scheme generation and maintenance capability.

With this in mind, the following description refers to numerous specific details which are set forth by way of examples to provide a thorough understanding of the relevant teachings. It should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings. It will be appreciated by those versed in the art that the exemplary teachings described herein enable sort schemes having associated sort parameters to be adapted dynamically.

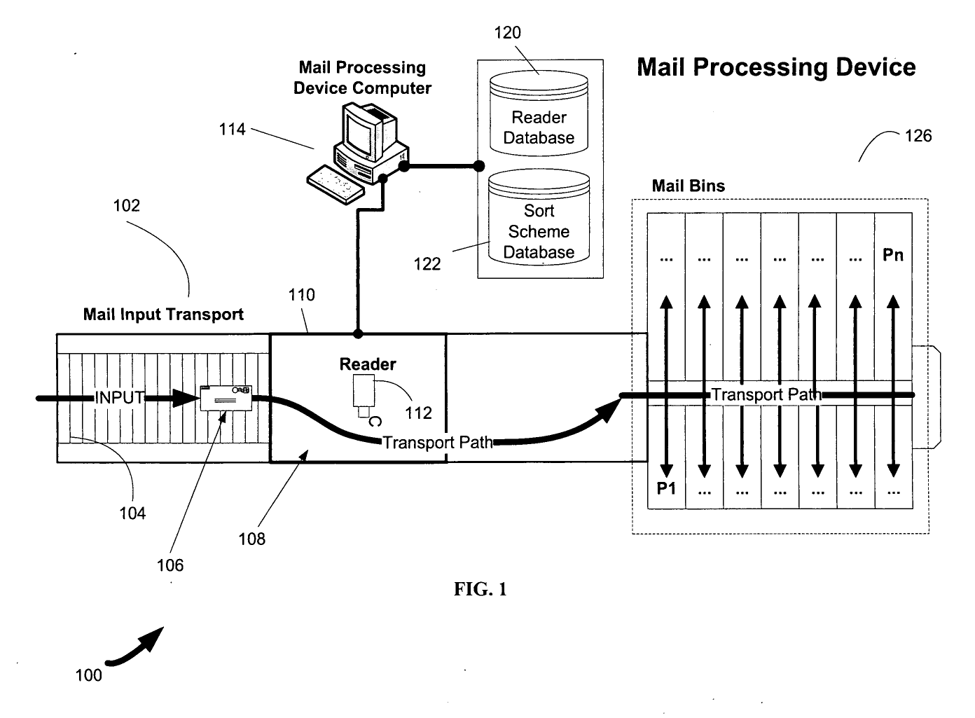

Turning attention to FIG. 1, a mail processing system is shown in the form of a high speed sorter device adapted to process mail items. A stream of addressed mail can be received as input to the sorter device, where each mail item may have one or more markings and/or delivery point identifiers thereon. For example, a type of delivery point identifier may include a ZIP code that is capable of being identified by a reader device 112. The delivery point identifier may be one type of sort parameter by which to process each mail piece in accord with a sort scheme managed by the control computer 114 into one or more mail pockets or bins P1-Pn 126. In addition to ZIP codes, other delivery point identifiers may include the recipient's name or entity name, street name, P.O. Box number, building name, barcode, postage or indicia, etc.

The mail processing system 100 may include a mail input transport component 102, including a grooved belt drive or conveyor belt system 104 for transporting a mail piece 106 and aligning it properly with a transport path 108. The transport path 108 defines the general direction that an incoming mail piece is guided along during its processing by the mail processing system 100. Coupled to the mail input transport component 102, is an image scanning or reader device 110, equipped with an imaging device such as an optical scanner or camera. The reader device 112 scans or images a mail item 106 to extrapolate the various physical characteristics of the mail item (e.g., height, weight), or at least the one or more delivery point identifiers on the mail piece, as it is processed by the mail processing system 100 along the transport path 108. Typically, the reader device 112 is placed upstream along the transport path 108 so that the address components can be scanned early on in the processing phase, and subsequently recognized or tracked against recognized data records using optical character recognition technology (OCR). Typical OCR systems include the optical scanner or reader 112 for reading text, and sophisticated software for analyzing images and features of the mail item. Alternatively, the OCR system may include a combination of hardware (e.g., specialized circuit boards) and software to recognize characters, or can be executed entirely through software. Those skilled in the art will recognize that various OCR systems may be employed by the reader device 112 for the purpose of interpreting or determining the physical characteristics of a mail item.

The reader device 112 may be controlled by a control computer 114, which as described above, may or may not execute the OCR utility. Generally, the control computer 114 is capable of executing various operating system mechanisms that control the behavior of the sorter 100 and devices associated therewith such as the reader device 112. The control computer 114 may also include a monitor capable of rendering an interface to a user of the mail processing system 100 for accessing, interpreting, and depicting the various images acquired by the reader device 112. Accessible by or resident upon the control computer 114 is a reader database 120, which contains data records of the plurality of recognized delivery point identifiers, markings and other data that may exist on a mail item. The reader database 120 can be customized from one enterprise to the next to include an enterprise's commonly known address components, unique identifiers and other markings potentially useable as sort parameters. Furthermore, when a mail item is imaged and OCR technology is used for interpreting the markings thereon, said markings may be compared to the data records within the reader database 120 to identify if the marking matches known data.

The control computer may also maintain a sort scheme database 122, wherein the various operational instructions used to affect the sorter's processing of mail items respective to the characteristics they convey may be stored. Hence, the reader 112 may enable the detection of one or more sort parameters by which a particular scheme maintained within the database 122 may be employed. Also, while not shown expressly, an inline scale, thickness detector, magnetic sensor, and various other measurement or detection devices may be placed along the transport path 108 of the sorter 100 for interpreting the characteristics of mail items, be they physical characteristics or those resulting from the placement of markings onto the mail item or its enclosures.

In the context of the examples herein, the term enterprise encompasses any arrangement of one or more mail processing systems intended for operation upon mail items. Also, the databases 120 and 122 as shown can be internally or externally located from the facility housing the mail processing system 100.

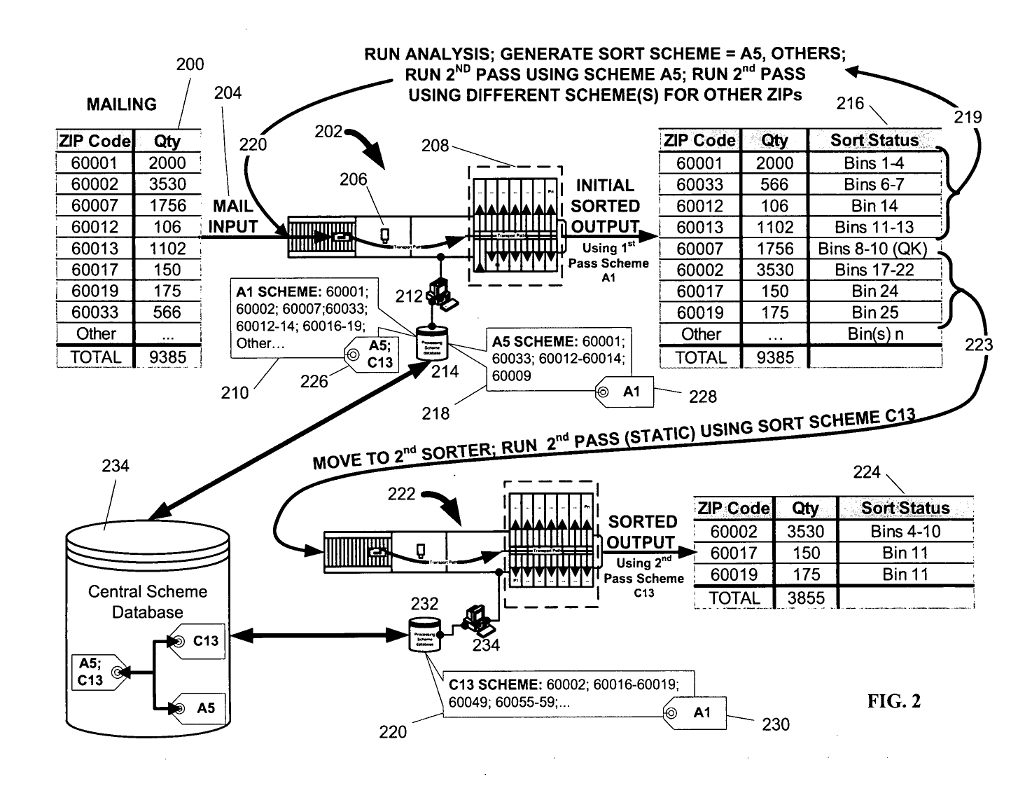

With reference now to FIG. 2, an exemplary mail processing task or job as performed by one or more sorter devices is shown. More specifically, FIG. 2 depicts an exemplary means for relating sort schemes executable by one or more sorters, the one or more sort schemes having sort parameters in common. In particular, a mailing 200 comprising a plurality of mail items having varying characteristics is provided as input 204 to a first sorter device 202. As shown, the characteristics of interest in the exemplary depiction are the ZIP Code designations, which for the purposes of sort processing are sort parameters by which to perform sorting of the mailing 200 into the mail bins 208. Hence, objectively, the mailing as made up of quantities of mail items displaying differing ZIP Codes are to be effectively sorted into the mail bins 208 as mail groupings. The sort parameters are identified, as discussed previously, via the usage of a reader device 206, whereupon identification, they are used to trigger the execution of a particular sort scheme. In this particular case, an initial sort scheme A1 210 is employed for sorting of mail items exhibiting specific sort parameters.

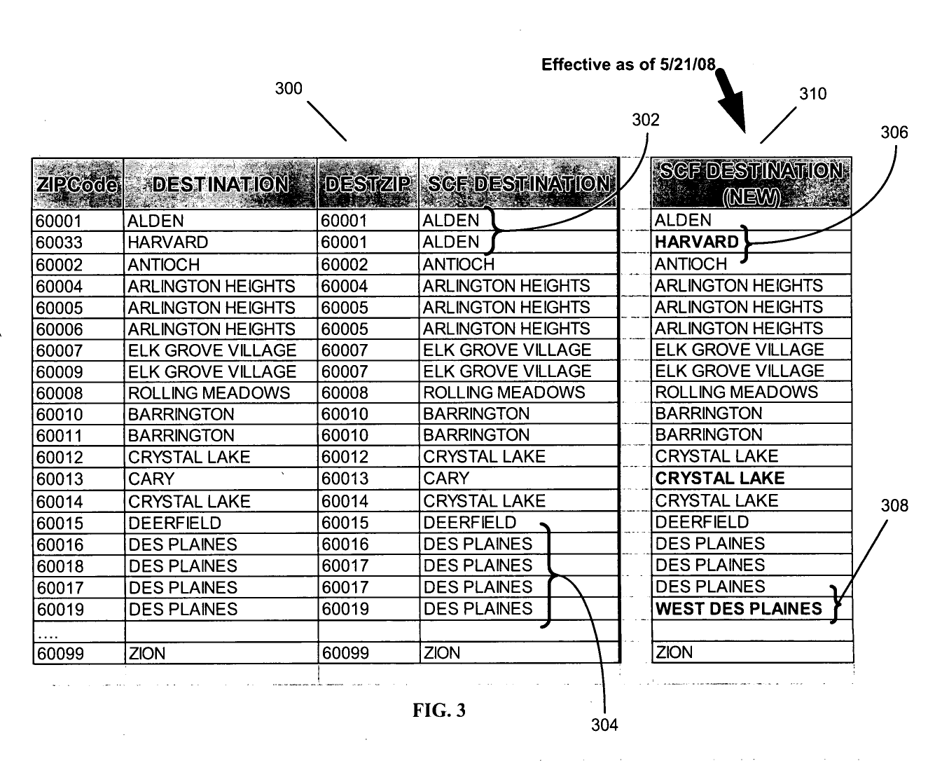

Sort scheme A1 210, as stored to a sort scheme database 212 accessible by the sorter control computer 214 of the first sorter 202, contains instructions for processing of mail items exhibiting the following sort parameters: 60001, 60002, 60007, 60033, 60012-60014, 60016-60019, 60037-60045, and other ZIP Code designations. In the exemplary figure, sort scheme A1 210 is used to perform first pass processing of the mailing, whereby the mail items may at be arranged initially into mail groupings and segregated into mail bins. Generally, first pass processing is useful for determining what the characteristics of the mailing is overall, but not necessarily for processing the mail to a finer level of sort as is typically intended for second pass processing. In addition to initial aggregation of mail groupings on the basis of sort parameters, other considerations factored into the first pass sort scheme logic may include, but is not limited to, bin capacity or postal authority scheme settings. More regarding postal authority scheme settings will be discussed with respect to FIG. 3. Suffice to say, first pass processing results in segregation of the mail items by grouping into the one or more mail bins, displayed as first pass status 216.

The first grouping of mail items exhibiting and associated with sort parameter 60001 (e.g., a ZIP Code designation placed upon the mail item as an identifier) is placed into bins 1-4. Mail bins 6-7, 14 and 11-13 maintain mail groupings exhibiting and associated with sort parameters 60033, 60012 and 60013 respectively. Mail bins 8-10 maintain a grouping of items exhibiting and associated with sort parameter 60007, which in the exemplary diagram, is a quick kill bin. A quick kill refers to any mail grouping that after first pass sort processing requires no further sorting—i.e., no second pass processing or finer level of sort is necessary for the mail items to quality for postal authority work sharing discounts. Hence, this particular mail grouping need not be swept for redirection through the first sorter 202, or any other sorter for that matter unless sort processing of this mail grouping on the basis of a different sort parameter is desired.

Finally, mail groupings exhibiting and associated with sort parameters 60002, 60017 and 60019 are placed into bins 17-22, 24 and 25 respectively in accord with sort scheme A1 210. In this example, all of the mail groupings with the exception of those associated with sort parameter 60007 require additional sort, and therefore at least second pass processing. Second pass processing, or subsequent processing, is generally intended for sorting of the mail items into finer sort groupings suitable for qualifying said groupings for postal authority work sharing discounts. Moreover, to the extent the initial pass enabled an inspection or analysis of the characteristics of the mail items that comprise the mailing 200, second pass processing enables more specific sort on the basis of said characteristics. In the exemplary figure, second pass processing is to be performed on the first sorter 202 using sort scheme A5 218, which has instructions for affecting the behavior of the sorter on the basis of mail groupings associated with sort parameters/ZIP Code designations 60001, 60033, 60012-60013. Sort scheme A5 218 may be composed based on the analysis of the mail as it was operated upon using initial sort scheme A1 210, or by other techniques via the sort scheme computer 212 running a sort scheme generation software utility. Suffice to say, second pass processing may be performed on the sorter by re-inputting 204 the mail exhibiting and associated with the aforementioned sort parameters into the sorter transport, as indicated by the arrows labeled 219 and 220.

In relation to this mailing 200, static second pass processing may also be performed based on advanced knowledge of the characteristics or sort parameters comprising the mailing 200 using sort scheme C13 220. Sort scheme C13 220 has instructions for affecting the behavior of the sorter on the basis of mail groupings associated with sort parameters/ZIP. Code designations 60002, 60017 and 60019. Advanced knowledge, in this example, may include sufficient data reflective of the characteristics of the mail items to be processed, such that initial analysis of the mail items need not be performed. Generally, static second pass processing is performed by a second sorter 222 so that the totality of the mailing 200 may be divided amongst multiple sorters rather than one for work distribution purposes. Furthermore, by enabling static second pass operation on the second sorter 222, the second pass operation occurring with respect to the first sorter 202 (via scheme A5 218) may be executed concurrent with that of the second sorter, hence maximizing overall sort processing efficiency. Suffice to say, static second pass processing may be performed on the second sorter 222 by inputting the mail exhibiting and associated with the sort parameters/ZIP Code designations 60002, 60017 and 60019, as indicated by the arrow labeled 223.

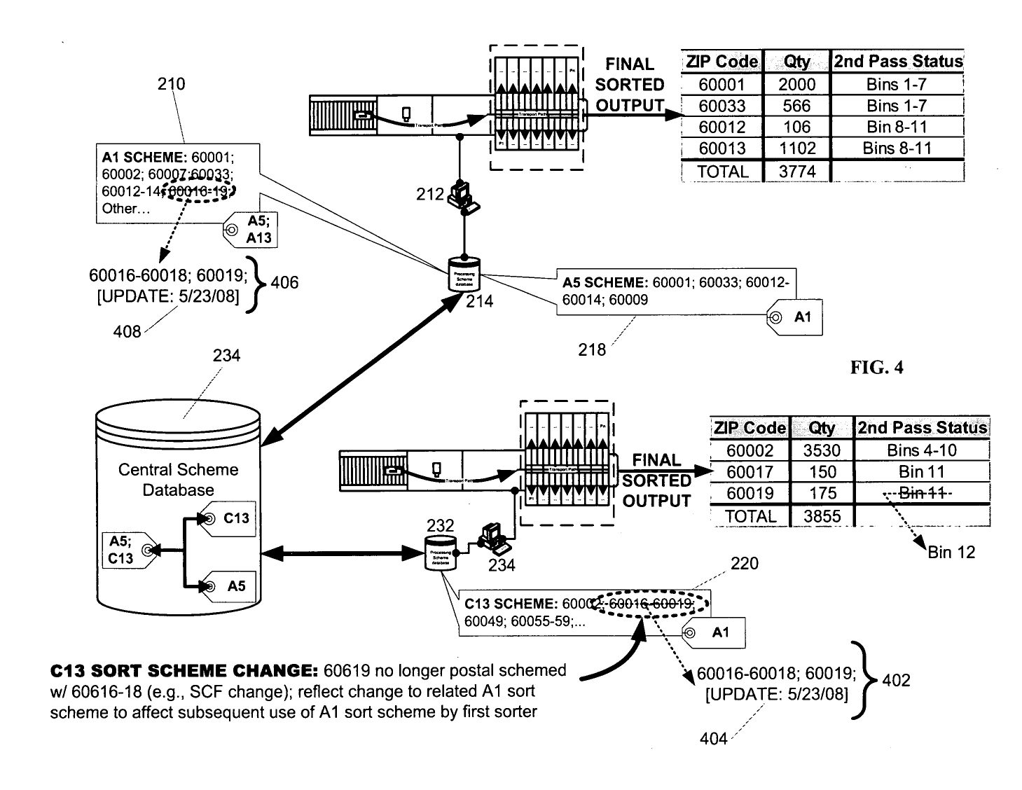

The results of second pass processing as performed by the first sorter 202 using sort scheme A5 218 is illustrated respective to FIG. 4. The results of static second pass processing as performed by the second sorter 222 using sort scheme C13 220 results in a finer sort of the mail items into various mail bins, displayed as sort status 224. In some limited instances, additional passes or sort processing runs may need to be executed for attaining a desired level of sort, although this is typically not effective in large quantity mail processing.

Those skilled in the art will recognize the static second pass processing need not be limited in performance to only a first or second sorter, but rather, may be performed using multiple other sorters (not shown). Varying sort operators, entities, etc. may employ differing sort distribution and processing schemes as required. In keeping with the exemplary teachings herein, each of the sort schemes as presented in FIG. 2 have one or more tags associated therewith for enabling reference of sort schemes to one another. More specifically, the tags provide a means for one sort scheme having instructions for operating upon mail items exhibiting or associated with one or more sort parameters to reference another sort scheme intended for operation upon mail items that exhibit or are associated with the same sort parameters. By enabling relational reference of sort schemes in this way, it will be seen that edits or changes made to one of the related schemes may be more readily adapted to the other.

In particular, initial sort scheme A1 210 is tagged 226 to indicate its association with sort scheme A5 218 and sort scheme C13 220. Also, sort scheme A5 218 is tagged 228 to indicate its association with sort scheme A1 210. Similarly, static second pass sort scheme C13 220 is tagged to indicate its association with sort scheme A1 210. As mentioned, each of the sort schemes are related to one another based on the one or more sort parameters they use to process mail items. So, for example, sort scheme A1 218 shares sort parameter 60001 in common with sort scheme A1 210, while sort scheme C13 220 shares sort parameters 60016-60019 in common with sort scheme A1 210. While not shown expressly, if either sort scheme A5 218 or C13 220 were to have sort parameters in common, their respective tags 228 and 230 would also indicate reference to sort scheme C13 220 and A5 218 respectively.

Generally, the tags 226, 228 and 230 may be implemented as pointers, wherein the value maintained by the pointer refers to (or “points to”) another value stored elsewhere in memory. So, the relational identification tag may reference a memory location within a particular sort scheme database 214 or 232 wherein the referenced sort scheme is stored. As a more advanced referencing technique, the relational identification tag may directly reference the location of the sort parameter of interest within the sort scheme dynamically. Still further, the relational identification tag may also reference the location of a specific logical instruction associated with the sort parameter in question. So, for example, let's assume a sort scheme—typically implemented as a scheme file corresponding to a particular scheme language—indicates the following instructions:

IF sort_parameter=60001 THEN sort_bin_available=1; 2; 3; 4.

This rudimentary instruction dictates that mail items associated with sort parameter 60001 are to be placed into the available of sort bins 1-4. In accord with the teachings, a relational identification tag may reference this particular instruction and/or the sort scheme for which the instruction is maintained.

Either way, when the relational identification tag is dereferenced, the value maintained by the pointer is retrieved—be it the location of the actual sort parameter within the sort scheme file that is expressly referenced, the location of the sort scheme file, the location of a particular instruction associated with a sort parameter, etc. Once the associated value is retrieved, this value may be accessed for use in editing and updating sort parameters or their associated logical instructions as prompted by a sort scheme generation software utility operating in conjunction with a particular control computer 212 or 234. So for example, if a change is made to a sort parameter within a sort scheme having an associated relational identification tag, the change is reflected to all other instances of the sort parameter as indicated within an associated sort scheme by virtue of the associative tag. Those skilled in the art will of course recognize other ways of associating and referencing data types or values may be employed other than pointers. Indeed, the exemplary techniques presented herein are applicable to all such means as required. Any techniques by which common values or parameters may be referenced and dynamically adapted is within the scope of the exemplary teachings herein.

While reference is made to memory and/or database access, skilled artisans will recognize that the teachings herein are not limited to any one particular database implementation. The term “database” is used to indicate any type of electronic data that is searchable or accessible by a computer or computer executable, be it in a distributed or centralized fashion, and is not intended to be limited by the actual hardware or software implementation. In the exemplary figure, though the sort scheme databases 214 AND 232 respective to the first 202 and second sorter 222 are depicted as being locally accessible, this need not be the case. Databases may be implemented in accord with various models and design methodologies for achieving varying operational and functional purposes. Furthermore, storage mediums upon which a database may be implemented or maintained may include, but is not limited to, disk storage such as DASD, RAID, or other mediums of varying volatility. The database may be implemented upon such mediums in accord with varying database file structures, languages or methodologies, including but not limited to Structured Query Language (SQL), Extensible Markup Language (XML), ordered/unordered flat files, Indexed Sequential Access Method (ISAM), heaps, hash buckets or Quarternary trees (B+ Trees). Those skilled in the art will select the combination of hardware and software according to the database design requirements specific to their particular application needs.

Optionally, an exemplary central scheme database 234 may be employed for maintaining information respective to the tags 226-230. This database may be implemented for keeping a record of the relationship between the various sort schemes 210, 218 and 220. So, for example, relational identification tag 226 as associated with sort scheme A1 references sort scheme A5 218 and sort scheme C13 220 (or perhaps referencing specific sort parameter locations within said respective sort schemes). Hence, this relational dynamic—i.e., parent-child—is maintained within the database. In this way, in cases where databases 214 and 232 are not communicable to each other directly, the relational identification tag relationships may be maintained using the central scheme database 234 as an intermediary. Consequently, relational identification tag maintenance may be facilitated regardless of the relative proximity of the first sorter 202 and second sorter 222. Alternatively, the relational dynamics may be inherently maintained by the respective databases 214 and 232, such as via a network configuration, without necessitating a central scheme database 234.

With reference now to FIG. 3, exemplary postal authority ZIP Code scheme data 300 is shown in the form of a table. The postal authority ZIP Code scheme data 300 indicates the various relationships between select ZIP Code designations and respective postal authority processing facilities at which mail items exhibiting or associated with said ZIP Code designations are to be processed. Exemplary postal authority processing facilities may include, but is not limited to, bulk mail centers (BMC), sectional center facilities (SCF), local mail centers, etc. The postal authority ZIP Code scheme table 300 of FIG. 3 represents one related to 5-digit ZIP Codes. For example, the data 300 indicates that mail items exhibiting 5-digit ZIP Code designations 60001 (specific to Alden, Ill.) or 60033 (specific to Harvard, Ill.) are to be directed to the sectional center facility in Alden, Ill. As another example, mail items exhibiting ZIP Code designations 60016-60019 (specific to Des Plaines, Ill.) are to be directed to the Des Plaines, Ill. SCF. When a plurality of distinctly different ZIP Codes are to be directed to a single postal authority processing facility, these ZIP Codes are said to be postal authority schemed ZIP Codes.

While postal authority ZIP Code schemes are not expressly within the scope of the teachings herein, a change in a postal authority ZIP Code scheme provides an example of a situation wherein a sort scheme is to be updated or changed. After all, mail items exhibiting or associated with schemed ZIP Code designations may be sorted to the same mail pocket despite their distinct difference given that they will ultimately be processed by the same postal authority processing facility. A change in a postal authority scheme would therefore need to be accounted for in creating sort schemes that affect the operations of a sorter. Consequently, the postal authority provides updated postal authority ZIP Code scheme data 300 periodically for use in achieving greater deliverability of mail items. Changes to such data (e.g., as shown with respect to data 310), for instance, may result due to the opening or closing of new postal authority processing facilities dedicated to processing mail items exhibiting or associated with a particular schemed ZIP Code. Such changes may also occur in instances where natural disasters or emergencies prevent directing of mail items to a given postal authority processing facility.

An example as shown in the figure with respect to data 310 is the addition of a Harvard, Ill. SCF 306 respective to schemed ZIP Code designations 60001 and 60033, or the addition of a West Des Plaines, Ill. SCF 308 respective to schemed ZIP Code designations 60015-60019. In the former, ZIP Code designation 60033 is no longer schemed with 60001, while in the later, ZIP Code designation 60019 is no longer schemed with 60016-60018. Consequently, a sort scheme developed respective to the prior postal authority ZIP Code scheme data 300 would not result in proper sort of mail items on the basis of the new postal authority ZIP Code scheme data 310.

With this in mind, FIG. 4 is an exemplary depiction of a plurality of high speed sorter devices—as shown originally in FIG. 1—adapting their respective sort schemes dynamically responsive to changes made to one of a related sort scheme. Such functionality is a feature attainable due to the tagging of the one or more sort schemes that are related to one another by virtue of one or more common sort parameters. It is assumed, for the purposes of this example, that sort schemes 210, 218 and 220 as depicted in FIG. 1 were developed at least in part respective to postal authority ZIP Code data 300. Consequently, for the sake of the example, instructions within a given sort scheme on this basis may have enabled the sort of mail items exhibiting or associated with sort parameters that are also schemed ZIP Code designations to the same mail bin within the sorter (e.g., 5-digit ZIP Codes 60007 and 60009 of data table 300).

However, responsive to updated exemplary postal authority ZIP Code scheme data 310, any applicable sort schemes would also require updating. For example, sort scheme C13 220 as intended for operation upon mail items exhibiting or associated with sort parameters 60016-60019 is updated to account for the change as presented. With the addition of the West Des Plaines mail processing facility/ZIP Code designation, mail items marked with 60019 are to no longer be grouped with mail items marked with 60016-60018, as 60019 is no longer a valid entry within the mail grouping. Consequently, this requires a change to sort scheme C13 220 respective to these particular sort parameters—be it the sort parameters themselves or the logical instructions associated therewith as comprises the sort scheme (e.g., bin assignments, diverters, inline processing modules). This adaptation process is depicted in FIG. 4, which shows an update 402 to the sort parameters of scheme C13 220 accordingly to reflect 60016-60018; 60019. In the exemplary figure, the separation of 60019 is meant to convey that 60019 is no longer a part of the postal sort scheme. Such adaptation may be performed by the sort scheme generation software available to the sort scheme computer 234 in various ways, including but not limited to: (i) enabling manual adaptation of the sort parameters and/or related sort scheme logical instructions associated therewith by way of a user interface and (ii) enabling dynamic adaptation of the sort parameters and/or related sort scheme logical instructions associated therewith by the sort scheme generation software itself based on updated postal authority ZIP Code scheme data (e.g., as imported from a third party address quality resource).

In the later case, the software utility may provide a user interface, including one or more executable menus, buttons or text editors for enabling adaptation of a sort scheme as presented to a display. In accord with the present teachings, relational identification tag and reference data associated with the sort scheme to be adapted may also be presented at this time. Relational identification tag information may be presented in the form of a list or visually by the software utility via access to the central scheme database 234 or via direct or network access to individual sort scheme databases 214 and 232. As the user is now able to inspect the sort scheme and its related tag(s), the user may invoke automatic adaptation of any referenced sort scheme(s), the adaptation being the same for the related sort scheme as the sort scheme under inspection. As an example, the same change 402 made to sort scheme C13 220, which is tagged with reference to sort scheme A1 210, is also translated accordingly to sort scheme A1 210 by way of example as change 406. By translated accordingly, it is meant that varying other factors such as bin assignment and other parameters of which a sort scheme is composed may also be adapted. Albeit in the case of bin assignment, this may require manual designation by a user in some instances, depending on the bin capacity of differing sorters. Regardless of how changes are translated, the fact that a sort scheme operable on the basis of one or more sort parameters may be associated with another sort scheme that operates on the basis of at least one of the same sort parameters is of significant value to skilled practitioners of the art.

Also, in association with this update is a newly assigned effective timestamp 404, which is a record of when the changes to the sort scheme took affect. So, in the example of sort scheme change 402, the date of adaptation (May 23, 2007) is associated with the sort scheme change. Likewise, the same timestamp would apply to any sort scheme of reference, so that it too may also reflect the corresponding date of change. This date of change 408 is shown by way of example in the figure. Of course, those skilled in the art will recognize that the effective timestamp 404/408 may be recorded in differing ways other than just the date (e.g., specific hour, minute, second). Furthermore, those skilled in the art will recognize that the timestamps for sort schemes related by virtue of one or more sort parameters may vary depending on the rate at which changes in one sort scheme are to be applied to another. Such nuisances will depend on the types of computing systems, network capacities, database methodologies, etc. employed.

While the exemplary techniques for enabling updating of the sort schemes is presented in FIGS. 2 and 4 from the perspective of sort parameters in the form of ZIP Code designations, those skilled in the art will recognize that sort schemes may be generated and/or updated in accord with the above described techniques respective to various other sort parameters. Such sort parameters may include but is not limited to: physical characteristics such as height, weight, color, or thickness and identifier based characteristics such as ZIP Code, barcode, indicia, sequence number, key line data, etc. So, for example, if sort scheme C13 220 of FIG. 4 were based entirely or in part sort parameters such as color or weight, a change in value to the color or weight would likewise be made to any other sort schemes related to C13 220 on the basis of these sort parameters. Indeed, the exemplary techniques presented herein contemplate all variations and combinations of sort parameters as is feasible in a sort environment for enabling effective sort of mail items.

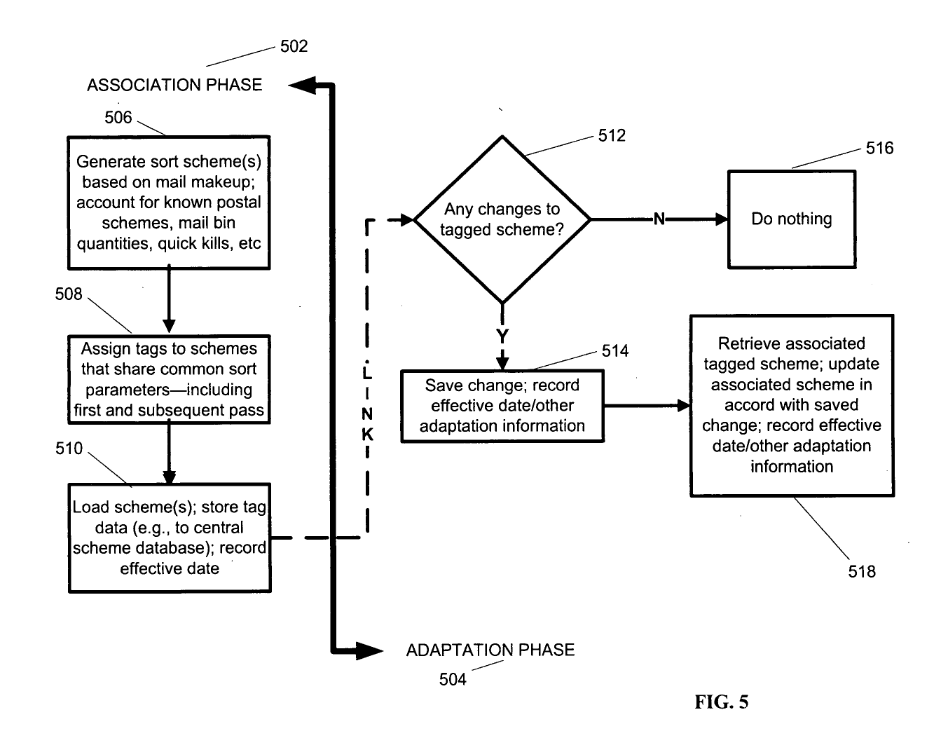

Turning now to FIG. 5, an exemplary flowchart depicting the process by which a change to one or more sort parameters respective to a first sort scheme may be made respective to other sort schemes associated with the same one or more sort parameters. Essentially, the flowchart is broken into two parts, namely the association phase 502 and the adaptation phase 504. The association phase 502 details steps for enabling sort schemes having one or more sort parameters in common to be associated with one another via the creation of tags. The adaptation phase 504 details the steps for enabling a change made to one sort scheme to be reflected or accounted for by another related sort scheme that shares one or more sort parameters in common.

As shown, in the association phase 502 sort schemes are generated responsive to particular mail characteristics of a mailing and various other criteria (event 506). The mail characteristics as exhibited (or expected to be exhibited) may eventually be employed as sort parameters, while the criteria may include considerations such as the number of mail bins available to the sorter, estimated work capacity, or predetermined bin assignments (e.g., quick kill or jackpot bins). Tags are then assigned—at the time of sort scheme generation or thereafter—to sort schemes that share common sort parameters (event 508). Alternatively, the tags may be assigned directly to a specific sort parameter, so as to enable reflectivity of said sort parameter respective to a plurality of schemes in which it may be employed. These tags enable said sort schemes or parameters to reference one another accordingly, hence enabling them to be linked. The data associated with each relational identification tag is then stored for future reference or recall (event 510). The data that comprises or is associated with a relational identification tag (e.g., a timestamp representative of the effective date of creation or adaptation) is discussed below.

In the event of a particular change being made to a sort scheme that is referenced by or linked to another sort scheme (event 512), the specific change made to said scheme is recorded and time stamped accordingly (event 514). Changes made to the sort scheme may include, but is not limited to changes made to specific sort parameters or other criteria that affect the operations of a sorter responsive to the characteristics exhibited by or associated with a mailing. Once the change is made, the relational identification tag associated therewith is retrieved, and the information is used to update the corresponding referenced sort scheme. Likewise, an effective timestamp is applied to the referenced sort scheme (event 518), or other information that may prove useful in subsequent historical analysis or adaptation of the various sort schemes. Other pertinent information respective to said updated sort scheme that may be maintained—i.e., as relational identification tag data—may include, but is not limited to: information descriptive of the party responsible for invoking the adaptation, sort scheme generator identification data, factors or conditions that led to the adaptation of the sort scheme (e.g., a note indicating that the change was made responsive to updated postal data table 300), etc.

Those skilled in the art will appreciate that the present teachings reduce the manual and often redundant modification that must occur when sort schemes exhibiting or associated with the same sort parameters are not associated in any way. In addition, the present teachings present a technique for enabling changes made to one sort scheme exhibiting or associated with one or more sort parameters to be accounted for in a sort scheme exhibiting or associated with at least one of those parameters. Said change may be applied only to the extent that the change is based upon the one or more sort parameters in common. Skilled artisans will recognize that the advantages and features presented herein will apply in any scheme based environment be it in an incoming or outgoing sorting environment.

The exemplary mail processing computer 124 of the mail processing system 100 may include a central processing unit (CPU), memories, and an interconnect bus. The CPU may contain a single microprocessor, or may contain a plurality of microprocessors for configuring the mail processing computer 124 as a multi-processor system. The memories include a main memory, a read only memory, and mass storage devices such as various disk drives, tape drives, etc. The main memory typically includes dynamic random access memory (DRAM) and high-speed cache memory. In operation, the main memory stores at least portions of instructions for execution by the CPU and data for processing in accord with the executed instructions.

The reader or sort scheme databases 120 and 122 may include one or more magnetic disk or tape drives or optical disk drives, for storing data and instructions for use by the CPU of the mail processing computer 124. For a workstation PC, for example, at least one mass storage system 208 in the form of a disk drive or tape drive, stores the operating system and application software as well as a data file. The bin configuration database 128 may also include one or more drives for various portable media, such as a floppy disk, a compact disc read only memory (CD-ROM or DVD-ROM), or an integrated circuit non-volatile memory adapter (i.e. PC-MCIA adapter) to input and output data and code to and from the mail processing device computer 124.

The mail processing device computer 124 also includes one or more input/output interfaces for communications, shown by way of example as an interface for data communications via a network or direct line connection. The interface may be a modem, an Ethernet card or any other appropriate data communications device. The physical communication links may be optical, wired, or wireless. The network or discrete interface may further connect to various electrical components of other document processing devices to transmit instructions and receive information for control thereof (e.g., print file information stored locally or as received remotely for enabling network printing). The network shall include any type of communication implementation for receiving and transmitting information to and from components of the mail processing system 100 and components external to and/or remote from the mail processing system 100.

The mail processing device computer 124 may further include appropriate input/output ports for interconnection with a display and a keyboard serving as the respective user interface. For example, the mail processing device computer 124 may include a graphics subsystem to drive the output display. The output display may include a cathode ray tube (CRT) display or liquid crystal display (LCD). Although not shown, the PC type system typically would include a port for connection to a printer. The input control devices for such an implementation of the system would include the keyboard for inputting alphanumeric and other key information. The input control devices may further include a cursor control device (not shown), such as a mouse, a trackball, a touchpad, stylus, or cursor direction keys. The links of the peripherals to the system may be wired connections or use wireless communications.

The mail processing device computer 124 shown and discussed is an example of a platform supporting processing and control functions of the mail processing system described herein. The control processing functions and the sort scheme capabilities discussed herein may reside on a single computer system, or two separate systems; or one or both of these functions may be distributed across a number of computers. Likewise, the control processing function and sort scheme operations may be implemented as one or more microprocessors or executable modules (e.g., firmware) that reside and operate upon the mail processing device computer 124.

The software functionalities of the mail processing device computer 124 involve programming, including executable code as well as associated stored data. Software code is executable by the mail processing device computer 124 that functions the system controller. In operation, the code and possibly the associated data records are stored within the mail processing device computer 124. At other times, however, the software may be stored at other locations and/or transported for loading into the appropriate general-purpose computer system. Hence, the embodiments involve one or more software products in the form of one or more modules of code carried by at least one machine-readable medium. Execution of such code by a processor of the computer platform enables the platform to implement the sort scheme and related document processing control functions, in essentially the manner performed in the embodiments discussed and illustrated herein.

As used herein, terms such as computer or machine “readable medium” refer to any medium bearing the code, algorithms, routines or instruction(s) that may participate in the functions of a processor and/or bearing one or more of the data files to facilitate dynamic labeling. Such a medium may take many forms, including but not limited to, non-volatile media, volatile media, and transmission media. Non-volatile media include, for example, optical or magnetic disks, such as any of the storage devices in any computer(s) operating as one of the system control platform, discussed above. Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution and/or in carrying one or more data files to a computer or to a printer.

In the previous description, numerous specific details are set forth, such as specific materials, structures, processes, etc., in order to provide a better understanding of the present subject matter. However, the present subject matter can be practiced without resorting to the details specifically set forth herein. In other instances, well-known processing techniques and structures have not been described in order not to unnecessarily obscure the present subject matter.

Only the preferred embodiments of the present subject matter and but a few examples of its versatility are shown and described in the present disclosure. It is to be understood that the present subject matter is capable of use in various other combinations and environments and is susceptible of changes and/or modifications within the scope of the inventive concept as expressed herein.

What is claimed is:

1. A method for generating a plurality of mail sort schemes used to control operation of one or more mail sorting devices, the method comprising steps of:
creating a first mail sort scheme and a second mail sort scheme, each mail sort scheme comprising instructions for sorting mail items, the instructions to be executed based at least in part on one or more mail item sort parameters common in each mail sort scheme;
generating a relational identification tag to associate the first and second mail sort schemes based on the one or more common mail item sort parameters;
storing the first and second mail sort schemes and the relational identification tag for access by the one or more mail sorting devices; and
referencing the second mail sort scheme by the relational identification tag when the first mail sort scheme is accessed by the one or more mail sorting devices.

2. The method of claim 1, wherein the step of creating the first and second mail sort schemes includes assigning an effective date to each mail sort scheme.

3. The method of claim 1, further comprising referencing the first mail sort scheme by the relational identification tag when the second mail sort scheme is accessed by the one or more mail sorting devices.

4. The method of claim 1, wherein the one or more sort parameters include identifiers selected from a postal ZIP Code, 2D Barcode, PLANET code, or a physical attribute including weight, height or thickness of a mail item.

5. The method of claim 1, further comprising creating a third mail sort scheme and associating the third mail sort scheme with the first and second mail sort schemes based on the one or more common mail item sort parameters.

6. A computer system programmed to implement the method of claim 1.

7. A software product comprising executable instructions for programming a computer to implement the method of claim 1, and a machine-readable medium bearing the instructions.

8. A method for updating a plurality of mail sort schemes having one or more mail item sort parameters in common, the method comprising steps of:
assigning a relational identification tag to a first mail sort scheme to reference the first mail sort scheme with a second mail sort scheme;
modifying at least one mail item sort parameter for the first mail sort scheme, the sort parameter being common to the first and second mail sort schemes;
storing the modified first mail sort scheme for access by the one or more sorting devices; and
automatically modifying the common mail item sort parameter in the second mail sort scheme as modified in the first mail sort scheme based on the assigned relational identification tag.

9. The method of claim 8, wherein the mail piece sort parameter including instructions for sorting mail pieces on one or more sorting devices.

10. The method of claim 8, further comprising storing the modified second mail sort scheme for access by the one or more sorting devices.

11. The method of claim 8, further comprising assigning a new effective date to each of the plurality of sort schemes upon updating thereof.

12. The method of claim 8, wherein the storing of the modified first and second sort schemes includes storing each of the modified sort schemes in a database.

13. The method of claim 8, further comprising:
modifying the at least one sort parameter for the first mail sort scheme, the sort parameter being common to the first and second mail sort schemes and to a third mail sort scheme;
automatically modifying the common sort parameter in the third mail sort scheme based on the assigned relational identification tag; and
storing the modified third mail sort scheme for access by the one or more sorting devices.

14. The method of claim 8, wherein the one or more sort parameters include identifiers selected from a postal ZIP Code, 2D Barcode, PLANET code, or a physical attribute including weight, height or thickness of a mail item.

15. A computer system programmed to implement the method of claim 8.

16. A software product comprising executable instructions for programming a computer to implement the method of claim 8, and a machine-readable medium bearing the instructions.

17. A system for generating a plurality of mail sort schemes used to control operation of one or more mail sorting devices, the system comprising:
a sort scheme generator adapted to:
create first and second mail sort schemes, each mail sort scheme comprising instructions for sorting mail items, the instructions to be executed by the one or more mail sorting devices based at least in part on one or more mail item sort parameters common in each mail sort scheme;
generate a relational identification tag to associate the first and second mail sort schemes based on the one or more common mail item sort parameters; and
a database for storing the relational identification tag and the first and second mail sort schemes for access by the one or more mail sorting devices,
wherein the relational identification tag references the second mail sort scheme when the first mail sort scheme is accessed by the one or more sorting devices.

18. The system of claim 17, further comprising: a user interface operable in connection with the sort scheme generator for allowing user definition of the mail item sort parameters.

19. The system of claim 18, wherein the system permits user modification of the one or more mail item sort parameters in the first mail sort scheme and the system automatically modifies each common mail item sort parameter in the second mail sort scheme.

20. The system of claim 18, wherein the system permits user modification of the one or more mail item sort parameters in the second mail sort scheme and the system automatically modifies each common mail item sort parameter in the first mail sort scheme.

21. The system of claim 17, wherein the one or more mailing sorting devices are selected from inbound sorting equipment or outbound sorting equipment.

22. The system of claim 17, wherein the one or more sort parameters include identifiers selected from a postal ZIP Code, 2D Barcode, PLANET code, or a physical attribute including weight, height or thickness of a mail item.

23. A method for generating an effective use date to a modified mail sort scheme, the method comprising steps of:
creating or modifying at least one mail item sort parameter in a mail sort scheme, the modified sort parameter affecting the operations of one or more sorting devices;
assigning an effective use date to the created or modified mail sort scheme; and
storing the effective use date for access by the one or more sorting devices.

24. The method of claim 23, wherein the creating or modifying step is conducted through a sort scheme generator.

25. The method of claim 24, further comprising: providing a user interface operable in connection with the sort scheme generator for allowing user creation or modification of the mail item sort parameters.

26. The method of claim 23, wherein the effective use date includes historical information about the created or modified mail sort scheme, the historical information selected from: a creation or modification date of the mail sort scheme, user information, sort scheme generator identification data or explanation for creation or modification of the mail sort scheme.

27. The method of claim 24, further comprising: creating or modifying a second mail sort scheme by the sort scheme generator utilizing the stored effective use date.
